(19) United States
(12) Patent Application Publication
(10) Pub. No.: US 2025/0193309 A1
(43) Pub. Date: Jun. 12, 2025

(54) SYSTEM AND METHOD FOR PROCESSING AND MANAGING COMMUNICATIONS IN AN EMERGENCY CALL CENTER

(71) Applicant: Invictus Apps, Inc., New York, NY (US)

(72) Inventors: Dylan Gleicher, Queens, NY (US); Neal Soni, New York City, NY (US)

(73) Assignee: Invictus Apps, Inc., New York, NY (US)

(21) Appl. No.: 18/974,083

(22) Filed: Dec. 9, 2024

Related U.S. Application Data
(60) Provisional application No. 63/607,499, filed on Dec. 7, 2023.

(51) Int. Cl. H04M 3/51; G08B 27/00; G10L 15/26; H04L 65/1045; H04W 4/90

(52) U.S. Cl. CPC H04M 3/5116; G08B 27/001; G10L 15/26; H04L 65/1045; H04W 4/90

(57) ABSTRACT

An emergency call center system having a communication processing system for processing communications between a 911 caller device and devices of a dispatcher and first responders, and for providing to devices of the dispatcher and first responders actionable insights related to the call. The communication processing system has a communication processing client that may be seamlessly integrated into the emergency call center system. The communication processing system also includes a cloud-based communication processing server that transcribes and analyzes audio data received from the communication processing client.

### CROSS REFERENCE TO RELATED APPLICATION

This application claims the benefit of and priority to U.S. Provisional Application No. 63/607,499, filed Dec. 7, 2023, the entirety of which is incorporated by reference herein.

### TECHNICAL FIELD

This patent application relates to call center systems and in particular emergency call center systems.

### BACKGROUND

When a caller makes an emergency call by dialing 911, the call is generally routed to the appropriate public safety answering point (“PSAP”) based on, for example, the caller's location. PSAPs may generally include a combination of computer, network, and telephony equipment for handling incoming emergency calls. FIG. 1 shows an example of an existing emergency call center (“ECC”) system 10 for a PSAP. The ECC system 10 includes a private branch exchange (“PBX”) 2 that receives emergency calls from the telephone of a 911 caller 1. The ECC system 10 also includes a session initiation protocol (“SIP”) server 3 that may perform several functions, including converting the call into SIP format and managing the converted SIP call. The SIP server 3 routes incoming calls to dispatchers 5₁ . . . 5ₙ. The PBX 2 and SIP server 3 generally reside in a PSAP network 6. One or more of the dispatchers 5 may also reside in the PSAP network 6.

Existing ECC systems, like ECC system 10, generally do not efficiently and effectively ingest, process, and analyze real-time audio and video data from 911 calls. For example, existing ECC systems generally do not effectively and efficiently transcribe calls from 911 callers and radio communications from first responders, do not provide real-time transcription of the calls to the appropriate recipients, provide translations of the transcription and/or generate actionable reports or insights based on these transcriptions, and/or do not effectively leverage artificial intelligence to do so. These failures of existing ECC systems may compromise outcome success and place lives in danger.

Deployment of existing ECC systems is generally disruptive to an ECC or PSAP. For example, integration of an existing ECC system into an ECC or PSAP may require modification and/or reconfiguration of other existing systems in the ECC or PSAP, for example the SIP server and/or PBX. Any changes to the ECC systems therefore may require additional modification and/or reconfiguration of other existing systems. In addition, existing ECC systems may also have limited scalability and/or resilience because, for example, they are not cloud-based.

Existing ECC systems may use available location information, for example Automatic Location Identification (ALI) information and/or mobile device GPS information, to identify the location of the emergency event. ALI may be provided by a telecommunications network or carrier and may be, for example, a physical address (for landlines) or geographic coordinate information (for mobile devices) of the caller. In some circumstances, the operating system manufacturer (e.g., Apple or Google) may provide the GPS location of the mobile device, which may be higher fidelity than the ALI information. This existing location information, however, is generally not sufficient to accurately identify the location where emergency assistance is needed. For example, the ALI information may be tied to a previous address associated with the telephone number or the mobile device may not be capable of transmitting a GPS signal. Moreover, the location of the caller (as represented by the ALI and/or GPS data) may be different than the location of the emergency. For example, a 911 caller may be calling on behalf of someone at a different location that is unable to make the call themselves.

### BRIEF DESCRIPTION OF THE DRAWINGS

FIG. 1 shows a prior art ECC system.

FIG. 2 shows an illustrative inventive ECC system.

FIG. 2A shows an example of a recipient device.

FIG. 2B shows an example of a recipient device.

FIG. 3 shows a PSAP network of an illustrative inventive ECC system.

FIG. 4 shows an illustrative embodiment of a communication processing system.

FIG. 5 shows an illustrative inventive ECC system.

FIG. 6 shows an illustrative embodiment of a communication processing server.

FIG. 7 shows an illustrative method for correlating call information.

FIG. 8 shows an illustrative recorder service.

FIG. 9 shows an illustrative transcription service.

FIG. 10 shows an illustrative livestream service.

FIG. 11 shows an illustrative structure for an emergency call record.

FIG. 12 shows an illustrative insights service.

FIG. 13 shows an example of role assignments performed by the insights service.

FIG. 14 shows an illustrative method for validating location.

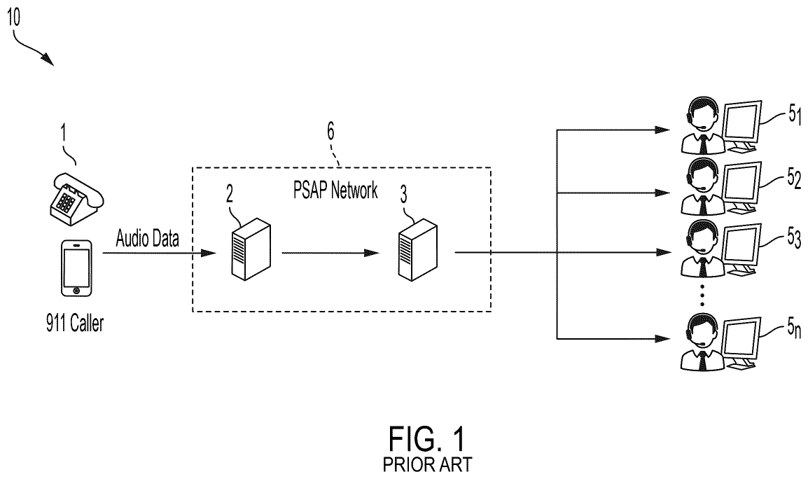

### DETAILED DESCRIPTION

A detailed description of examples of preferred embodiments is provided below. While several embodiments are described, the new subject matter described in this patent specification is not limited to any one embodiment or combination of embodiments described herein, but instead encompasses numerous alternatives, modifications, and equivalents. In addition, while numerous specific details are set forth in the following description to provide a thorough understanding, some embodiments can be practiced without some of these details and even without all of the described details. Moreover, for clarity and conciseness, certain technical material that is known in the related technology have not been fully described in detail, to avoid unnecessarily obscuring the new subject matter described herein. It should be clear that individual features of one or several of the specific embodiments described herein can be used in combination with features of other described embodiments or with other features. Further, like reference numbers and designations in the various drawings indicate like elements.

Embodiments described herein include an improved ECC system that addresses the technical deficiencies of the prior systems described above. For example, embodiments of ECC systems described herein efficiently and effectively ingest, process, and analyze real-time audio and video data from 911 calls. Embodiments of ECC systems described herein parse the conversation in real time and automatically identify issues for escalation using, for example, artificial intelligence. Embodiments of ECC systems described herein capture emergency call audio and/or video data, process the data, and transmit the data in real-time to agents and/or first responders both inside and outside the PSAP.

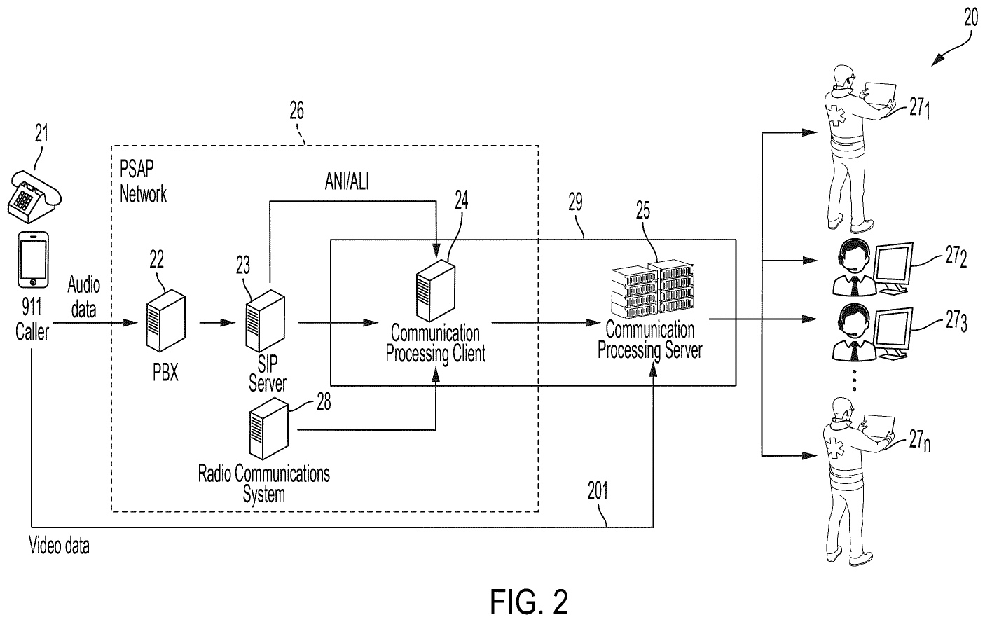

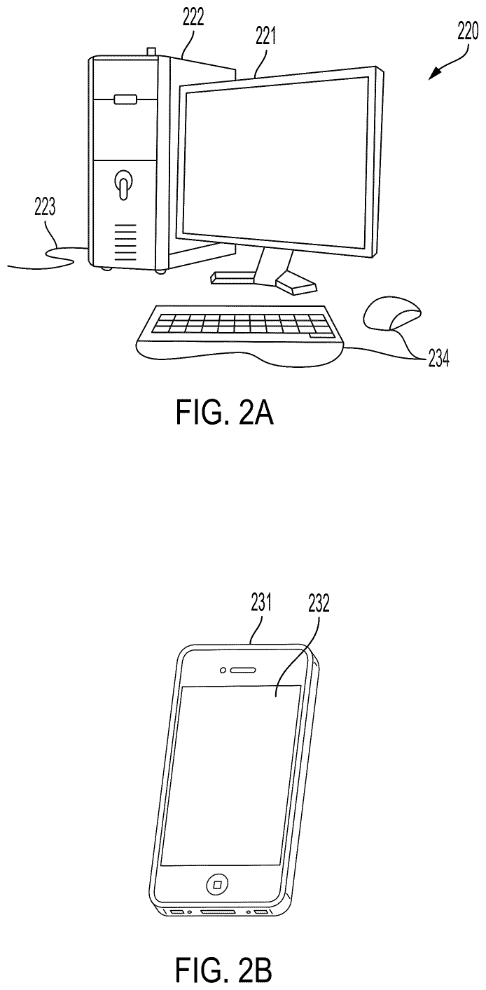

FIG. 2 shows an embodiment of an inventive ECC system 20 that addresses at least some of the technical problems described herein. ECC system 20 includes inventive communication processing system 29. Communication processing system 29 includes a communication processing client 24 in the PSAP network 26 and a communication processing server 25, which may be outside of the PSAP network 26 and may be cloud-based. Communication processing client 24 may reside on its own computer, or may reside on the same computer as one more of the other PSAP applications or systems. Communication processing system 29 may be configured such that most or all of the business logic and functionality occurs in the cloud-based communication processing server 25, allowing the communication processing system 29 to be highly scalable and resilient and with increased failover.

ECC system 20 includes a PBX 22 configured to receive emergency calls from a 911 caller device 21. ECC system 20 also includes a SIP server 23 connected between PBX 22 communication processing system 29. ECC system 20 may also include a radio communications system 28 for managing radio communications. ECC system 20 is configured to provide information to, and receive information from, various recipient devices 27. Recipients with devices 27 may include, for example, PSAP staff such as PSAP dispatchers, PSAP supervisors and PSAP QA staff, first responders such as police, fire and medical, state officials, and staff of other PSAPs. One or more of the recipient devices 27 may be within the PSAP network 26.

An example recipient device, computing system 220, is shown in FIG. 2A. Computing system 220 includes a processing device 222, for example a desktop computer. Computing system 220 also includes an output device 221, which may be a monitor, and input devices, which may include a keyboard and mouse. Computing system 220 also includes a network connection 223, which may be wired or wireless.

Another example recipient device shown in FIG. 2B is mobile device 231. Mobile device 231 may be a cellular telephone, tablet or other mobile device. Mobile device 231 has a screen 232, which may be a touch screen, allowing for user input and output.

SIP server 23 may be generally configured to convert the analog calls of the PBX 22 into digital SIP call data. SIP server 23 may also initiate, modify, and terminate communications, for example, audio calls, video calls, instant messaging and conferencing. SIP Server 23 may also handle call setup, routing of messages, registration of users, and maintenance of user location information. SIP server 23 may be any known and/or commercially available SIP server.

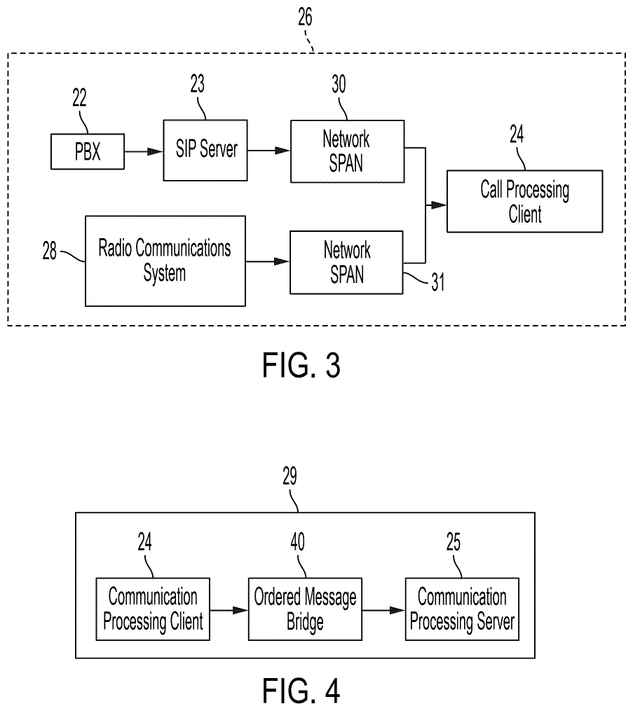

Communication processing client 24 may be configured to obtain SIP data from the SIP server 23. In one embodiment, the communication processing client 24 may monitor a network switched port analyzer (“SPAN”) 30 (FIG. 3) that is configured to mirror all SIP packets and network packets of the SIP server 23. In this way, communication processing system 29 may be seamlessly integrated into an existing PSAP network and/or ECC system. For example, the network SPAN 30 may allow the communication processing client 24 to receive SIP data from the SIP server 23 without any modification to the SIP server 23 and/or with minimal impact to the PSAP network 26. The network SPAN 30 and communication processing client 24 may reside on the same computer or different computers. Communication processing client 24 may instead be configured to receive SIP data from the SIP server 23 in any other known manner, for example using the SIP Recording (SIPREC) protocol.

Radio communication system 28 generally converts wireless radio communications into a digital format, for example SIP data. Radio communication system 28 may include, for example, existing systems from Motorola, AvTech or Zetron that manage radio communications. Communication processing client 24 may be configured to obtain digital radio communications, for example SIP radio data, from the radio communication system 28. The digital radio communications may include additional information such as timestamp and speaker identification information, in addition to the communications.

In one embodiment, the communication processing client 24 may monitor a network SPAN 31 (FIG. 3) that is configured to mirror the digital radio communications of the radio communication system 28. In this way, communication processing system 29 may be seamlessly integrated into an existing PSAP network and/or ECC system. For example, the network SPAN 31 may allow the communication processing client 24 to receive digital radio communications from the radio communication system 28 without any modification to the radio communication system 28 and/or with minimal impact to the PSAP network 26. The network SPAN 31 and communication processing client 24 may reside on the same computer or different computers.

Communication processing client 24 may be configured to receive data from the radio communication system 28 in any other known manner. Communication processing client 24 may also be configured to receive Automatic Number Identification (ANI) and Automatic Location Identification (ALI) data (“ANI/ALI data”) from SIP server 23. SIP server 23 may provide the ANI/ALI data to communication processing client 24 using, for example, a serial connection. Alternatively, or in addition, SIP server 23 may provide the ANI/ALI data to communication processing client 24 using, for example, webhooks or WebSockets.

In embodiments described herein communication processing client 24 uses the SIP packets obtained from the SIP server to obtain raw audio packets of the emergency call. Communication processing client 24 may obtain the raw audio packets by listening to the source and destination IP addresses of the call. Communication processing client 24 may obtain the source and destination IP addresses, for example, from the initial SIP packets. Communication processing client 24 then uses the network SPAN 30 to monitor communications between the source and destination IP addresses, and to capture the raw audio data from those communications. Communication processing client 24 may capture raw audio from the SIP packets received from the radio communication system 28 in a similar manner.

Communication processing client 24 may also capture certain metadata associated with the call or communication. For example, communication processing client 24 may capture from the SIP packets obtained from the network SPAN 30 a SIP internal phone number associated with the call and referred to herein as a “pseudo ANI” and a SIP extension and/or a scat number of the dispatcher handling the call. In addition, when the communication processing client 24 receives SIP packets indicating that a new call has been received, communication processing client 24 may assign a unique call identifier to the call to uniquely identify the call.

Communication processing client 24 is configured to send the raw audio data, the ANI/ALI data and the relevant metadata (including the unique call identifier) to communication processing server 25. In one embodiment shown in FIG. 4, communication processing system 29 may include an ordered messaging bridge 40 arranged between the communication processing client 24 and communication processing server 25. In this embodiment, the communication processing client 24 sends the raw audio data, the ANI/ALI data and the relevant metadata to the ordered messaging bridge 40, where it may be placed in a first-in-first-out (FIFO) queue, which may be a subscription-based queue. The communication processing server 25 may be configured to listen or subscribe to the ordered messaging bridge 40 and take the data from the ordered messaging bridge 40 in the same order it was added. In a preferred embodiment, ordered messaging bridge 40 resides in the cloud, but it may also reside in the PSAP network 26 or other location. Ordered messaging bridge 40 may employ, for example, protocol buffers (Protobuf) to serialize the data in the ordered messaging bridge 40. Communication processing client 24 may use other means to forward the raw audio data, the ANI/ALI data and the relevant metadata to communication processing server 25, for example shared memory, web services, or function calls. According to various embodiments described herein, communication processing server 25 may then process the data and provide information related to the data to one or more recipient devices 27.

When a SIP packet identifies that the list of call recipients has changed, for example if a call was transferred or another recipient has been conferenced in, communication processing client 24 will send metadata to the ordered messaging bridge 40 indicating this change in recipients.

As shown in FIG. 2, communication processing server 25 may be configured to receive video data via a direct video data connection 201 to the 911 caller device 21. The direct video data connection 201 may be, for example, a WebRTC connection. Alternatively, the 911 caller device 21 may send video data through the SIP server 23, and that video data may then be received by the communication processing client 24, which may process the video data in a similar manner to that described with regard to the audio data, and may send raw video data and/or extracted raw audio data, ANI/ALI data and relevant metadata to the communication processing server 25.

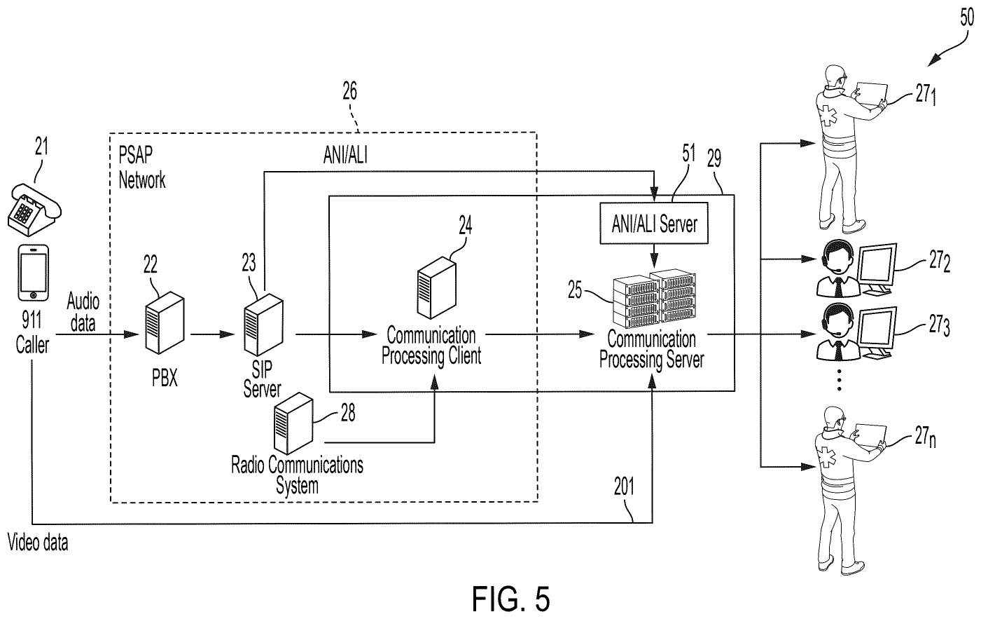

FIG. 5 shows another embodiment of an ECC system 50. ECC system 50 is substantially the same as ECC system 20 (FIG. 2), except that in ECC system 50 SIP server 23 provides the ANI/ALI data to the communication processing server 25, and not to the communication processing client 24 as in ECC system 20. ECC system 50 may include an ANI/ALI server 51, which may be included in the communication processing system 29. ANI/ALI server 51 may include an ordered messaging bridge or other type of FIFO or ordered structure. In this example, SIP server 23 sends the ANI/ALI data to the ANI/ALI server 51, and communication processing server 25 listens to or is subscribed to the ANI/ALI server 51 to retrieve new data when it is available. SIP server 23 may alternatively send the ANI/ALI data directly to the communication processing server 25 and/or ANI/ALI server 51, or through any other intermediate devices or interfaces. SIP server 23 may provide the ANI/ALI data to the ANI/ALI server 51 and/or communication processing server 25 using any known means of doing so, for example by using a webhook. Alternatively and/or additionally, communication processing server 25 may receive other location data, such as EED and ELS data that are generally provided by operating system developers.

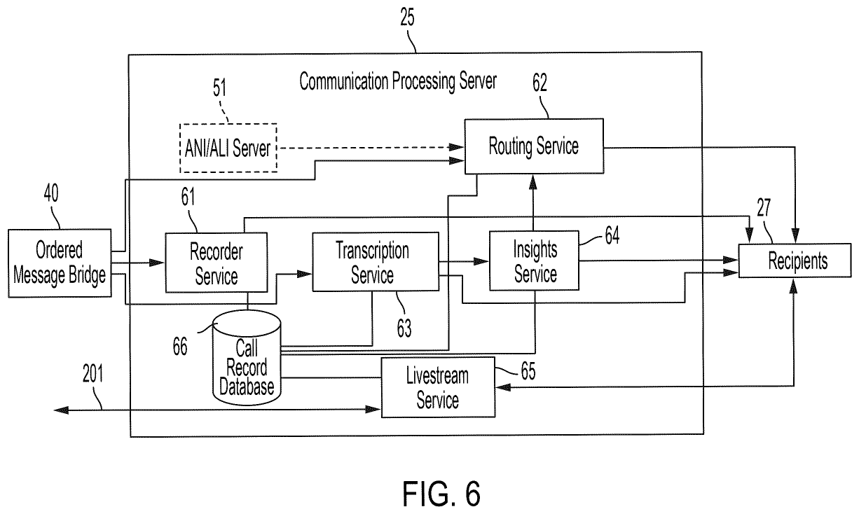

FIG. 6 shows an embodiment of communication processing server 25, which includes a recorder service 61, routing service 62, transcription service 63, insights service 64, livestream service 65 and call record database 66. The embodiment of communication processing server 25 shown in FIG. 6 also shows optional ANI/ALI server 51, which is arranged to provide ANI/ALI to the routing service 62. Livestream service 65 is configured to receive video data from the 911 caller device 21 via video data connection 201. Recorder service 61, routing service 62, transcription service 63, insights service 64 and livestream service 65 are each configured to read from and write to the call record database 66.

Routing service 62 is configured to receive raw audio and/or video data, ANI/ALI data and relevant metadata from the communication processing client 24 (e.g., via the ordered messaging bridge 40). Routing service 62 may also and/or alternatively be configured to receive ANI/ALI data from the SIP server 23 (e.g., via the ANI/ALI server 51, FIG. 5). Routing service 62 is generally responsible for correlating call information from various sources and storing that information in the emergency incident record database.

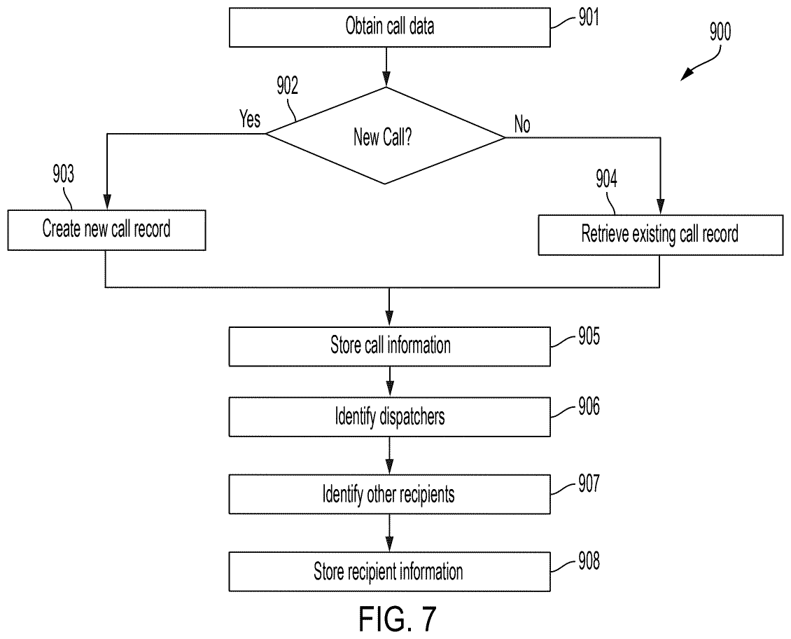

FIG. 7 shows a method 900 performed by routing service 62 for correlating call data. At step 901, the routing service 62 obtains the raw audio and/or video data, ANI/ALI data and relevant metadata, as described above, for example from communication processing client 24 via ordered message bridge 40. Alternatively and/or additionally, routing service 62 may obtain location data from an NG911 core service provider and/or from the operating system provider. At step 902, the routing service 62 determines if the call is a new call or an existing call. For example, routing service 62 may query call record database 66 for the unique call identifier associated with the call and received from the communication processing client 24 with the relevant metadata. If the unique call identifier exists in call record database 66, then the call already exists and is not new. If the unique call identifier does not exist in call record database 66, then the call is new.

If the call is new, in the next step 903 the routing service 62 creates a new call record in the call record database 66. If the call is not new, at step 904 the routing service 62 retrieves from the existing record for the call from the call record database 66.

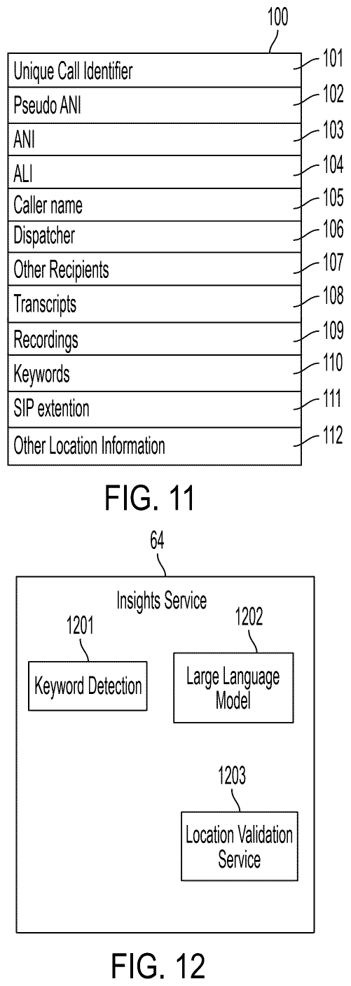

FIG. 11 shows an illustrative structure of a call record 100 in the call record database 66. Call record 100 includes a unique call identifier 101, a pseudo-ANI 102, an ANI 103, an ALI 104, 911 caller name 105, an identifier for the assigned dispatcher or its device 106 and identifiers for other assigned recipients and/or their devices 107 authorized to receive additional information or updates regarding the call. Call record 100 may also include a reference to one or more stored transcripts 108, a reference to one or more stored recordings 109 and one or more keywords 110 identified by a review of the transcript(s), for example by the insights engine 64. Call record 100 may also include fields that allow each call record to be associated with other call records for the same incident. Call record 100 may also store any other available location information 112, for example EED and/or ELS information. The fields 101-112 of call record 100 in FIG. 11 may be in multiple different database tables, or in the same database table. The fields 101-112 of call record 100 in FIG. 11 may represent a single field or multiple fields in one or more tables.

At step 905, the routing service 62 updates the new or retrieved call record 100 from call record database 66 with other metadata or information received. For example, routing service 62 may store a SIP extension, seat number and/or ALI information received from communication client 24. When the metadata obtained by the routing service 62 indicates a change in the list of recipients, based for example on a call being transferred or a caller being added, routing service 62 will update the call record 100 to reflect this change.

At step 906, routing service 62 identifies the recipient devices 27 associated with the SIP extension, seat number and/or location. For example, to identify the assigned dispatcher device(s), routing service 62 may maintain a table of dispatchers and/or dispatcher devices, SIP extensions and/or seat numbers, and identify the dispatcher devices by searching this table for the dispatcher or dispatcher device associated with the SIP extension and/or seat number. At step 907, the routing service 62 identifies other recipient devices that should be associated with the emergency call, for example those of nearby first responders. In this example routing service 62 may identify nearby first responders by performing geospatial algorithms on the received location data. For example, routing service 62 may search for all first responders within a desired range of the ALI or other location information, or may determine the first responder closest to the location, and include that first responder(s) in the list of other recipients 107.

First responder location information may be obtained from, for example, a PSAP computer-aided dispatch (CAD) system or automatic vehicle location (AVL) system. This location information may be obtained from, for example, communication processing client 24 (FIG. 2), which may send that location information to the communication processing server 25 (FIG. 2) as described herein. Alternatively, the communication processing server 25 (FIG. 2) may obtain the location information directly from, for example, the CAD or AVL system. The location information may originate from, for example, body cameras or mobile radios. The CAD or AVL system may also identify first responder devices related to the emergency call. Alternatively, one or more first responder devices may be identified by the dispatcher device or other PSAP device.

At step 908, routing service 62 updates the new or retrieved call record with the recipient information. For example, if a dispatcher was identified in step 906, the dispatcher field 106 may be updated with this new dispatcher information. Also, if other recipients were identified, for example first responders based on location as described in step 907, the other recipients field 107 is updated with this recipient information sufficient to identify the recipient devices.

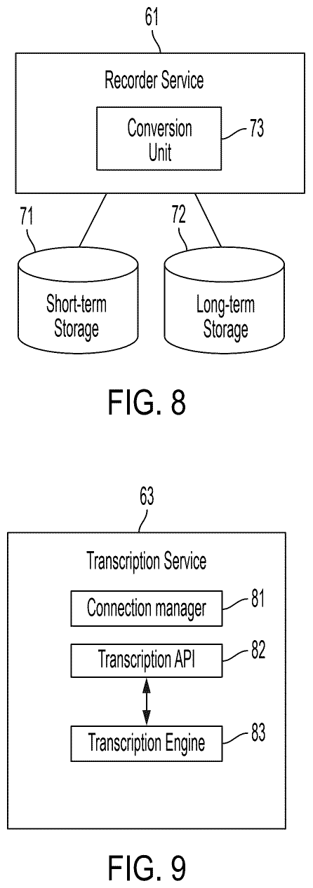

FIG. 8 shows an illustrative embodiment of recorder service 61. The recorder service 61 is configured to receive raw audio and/or video from the communication processing client 24, for example via the ordered messaging bridge 40. The recorder service 61 may also be configured to receive ANI/ALI data and relevant metadata from the communication processing client 24 (e.g., via the ordered messaging bridge 40) or from the SIP server 23 (e.g., via the ANI/ALI server 51). The recorder service 61 is configured to store all or some of the data it receives.

As shown in the embodiment in FIG. 8, recorder service 61 may include a conversion unit 73 and may interface with short-term storage 71 and long-term storage 72. Short term storage 71 may be a highly available distributed storage on disk. Short term storage 71 may be, for example, a REDIS cache. Long term storage 72 may be, for example, a cloud storage such as Amazon Web Services S3. Recorder service 61 may store raw audio data or video data packet by packet in the short-term storage 71. When a call or conversation is complete, the recorded raw audio or video data may be copied or moved from the short-term storage 71 to the long-term storage 72. Audio or video data stored by recorder service 61 may be made available to, for example, PSAP supervisors or QA staff for playback and/or download.

Recorder service 61 may update the appropriate call record 100 in the call record database 66 with information sufficient to identify the recording 109, and may make the recording available to the dispatcher device identified by the dispatcher field 106 and/or other recipient devices identified in the other recipients field 107.

Recorder service 61 may transform and/or convert the raw audio data or raw video data using conversion unit 73. For example, audio data received in L16 (16-bit linear PCM) format may be transformed using a mu-law algorithm, and video data received in VP8 format may be converted to H.264. Conversion unit 73 may perform the conversion or transformation before or after the data is stored.

Referring to FIG. 6, transcription service 63 is configured to receive raw audio and/or video, ANI/ALI data and relevant metadata from the communication processing client 24, for example via the ordered messaging bridge 40. Transcription service 63 may also receive the raw audio and/or video data directly from the 911 caller device 21 (FIG. 2) and/or recipient device 27. Transcription service 63 may also receive audio data from a session border controller. The transcription service 63 may also be configured to receive ANI/ALI data from the SIP server 23 (e.g., via the ANI/ALI server 51).

Transcription service 63 transcribes the raw audio and/or the audio from the raw video into text. Transcription service 63 may provide real-time, in-progress transcription of the call or conversation. Transcription service 63 may also provide a complete transcript of the call or conversation when it has completed. Transcription service 63 may receive audio data in any language, and may transcribe the audio data into text in the same language or a different language. Transcription service 63 may perform the necessary translation using, for example, translation APIs and/or artificial intelligence.

FIG. 9 shows an example embodiment of transcription service 63 where the transcription is performed by a transcription engine 83. In this embodiment, the transcription service 63 may use a transcription API 82 to access the transcription engine 83. The transcription engine 83 may reside in the transcription service 63 as shown in FIG. 9, but also may be reside in a different service and/or on a different computer. The transcription service 63 may use connection manager 81 to manage connections to the transcription API and/or transcription engine 83. The connections may be, for example, WebSocket connections. In one embodiment, the connection manager 81 maintains one WebSocket connection per call or conversation. A different transcription engine 83 instance may be used for each call or conversation. The transcription API 82 may take as input, for example, a single packet of audio data, or multiple packets of audio data, and may return the text associated with the received packet or packets to the transcription service 63. The transcription API 82 may also return to the transcription service 63 information related to identification and differentiation between multiple speakers (diarization).

The transcription service 63 may process the audio data using a transcription engine 83 specifically tuned for radio acoustics to improve accuracy of transcription of low-quality audio or audio that includes interference or static. Transcription service 63 may use timestamp and/or speaker identification information received with the raw audio or video data to prepare the transcriptions. For example, transcription service 63 may use the timestamp and/or speaker identification information to partition the transcribed text based on speaker.

Transcription service 63 may update the appropriate call record 100 in the call record database 66 with information sufficient to identify the generated transcript(s) 108, for example a pointer to location of the stored transcript in long-term storage 72 or call record database 66. Transcription service 63 may make the transcript(s) available in real time to the dispatcher device identified by the dispatcher field 106 of the appropriate call record 100 and/or other recipient devices identified in the other recipients field 107. Alternatively and/or in addition, transcription service 63 may make the complete transcript(s) available to the dispatcher device identified in the dispatcher field 106 and/or other recipient devices identified in the other recipients field 107.

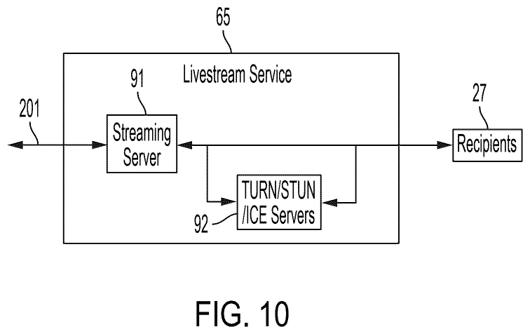

Referring again to FIG. 6, livestream service 65 receives a video stream from 911 caller device 21 (FIG. 2) via video data connection 201 and provides the video stream to one or more recipient devices 27. FIG. 10 shows an example embodiment of livestream service 65. Livestream service 65 includes a streaming server 91 that receives video data from 911 caller device 21 (FIG. 2) via video data connection 201 and sends the video data to the appropriate recipient devices 27. Livestream service 65 may obtain the appropriate recipient devices by retrieving the call record 100 from call record database 66. Livestream service 65 may also include STUN/TURN/ICE servers 92, which facilitate the establishment of connections from the streaming server 91 to the recipient devices through, for example, Network Address Translation (NAT) and where direct connections are impeded by firewalls. STUN/TURN/ICE servers 92 may also reside outside of the livestream service 65.

Video data connection 201 may use any video streaming protocol, for example WebRTC. Streaming server 91 may stream video to recipient devices 27 using any video streaming protocol, for example WebRTC. Streaming server 91 may perform any necessary conversion on the video data before sending the video on. Streaming server 91 may use different protocols to stream video to different recipient devices 27. For example, streaming server 91 may convert the video data into a format suitable for low-latency streaming (e.g., via WebRTC) to recipient devices 27, which may include first responders or dispatchers operating under varying network conditions. While livestream service 65 is described herein for streaming video, livestream service 65 may also stream audio or other data.

Referring again to FIG. 6, insights service 64 is configured to receive, for example, real-time and/or complete transcriptions from transcription service 63. FIG. 12 shows an example embodiment of the insights service 63. Insights service 63 may include keyword detection component 1201, large language model 1202 and location validation service 1203. Insights service 64 may be configured to ingest various data sources and to generate actionable reports, insights, alerts and/or notifications tailored to specific user roles involved in emergency response. Embodiments of the insights service 64 enhance the decision-making process, providing critical information to dispatchers and field responders in real time.

In an example embodiment, insights service 64 ingests transcriptions received from transcription service 63, processes the transcriptions, and uses the results of this processing to, for example, prepare tailored reports or insights and/or raise alerts or notifications. Insights service 64 may process the information using natural language processing, for example a large language model 1202. Alternatively, or in addition, insights service 64 may use keyword detection component 1201 to process the information by searching for pre-configured keywords. Each pre-configured keyword can be assigned by a PSAP to a role(s) or individual(s). The keywords, reports, alerts and/or notifications may all be pre-configured by a PSAP to align with specific communication protocols and/or operational needs of the PSAP.

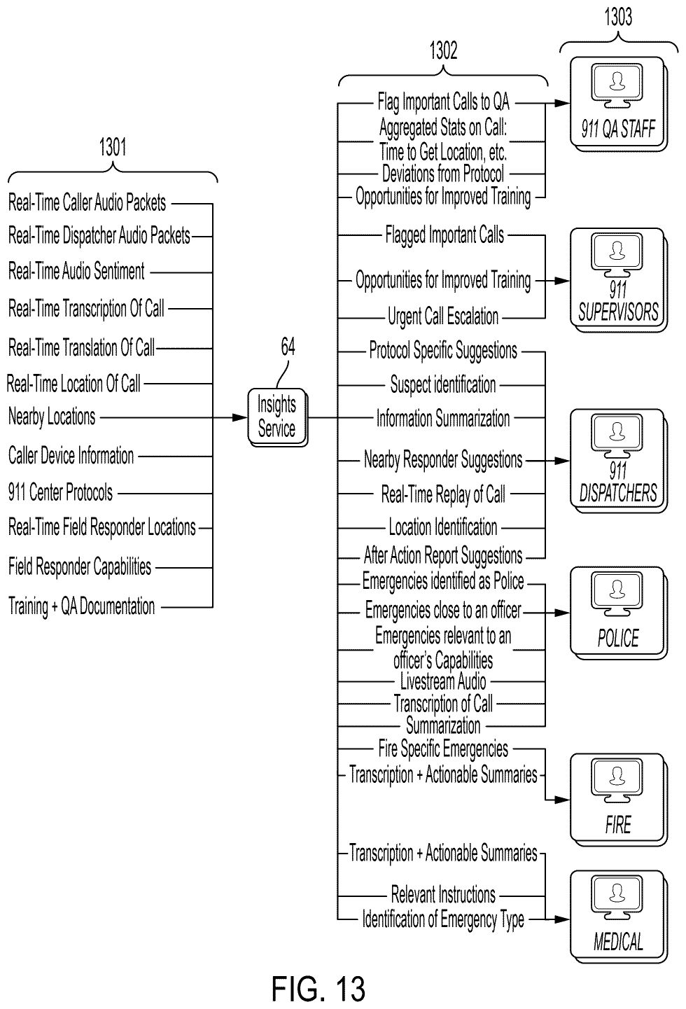

In one example, insights service 64 may receive transcribed text from transcription service 63, for example in real time, and process the transcribed text to identify keywords (e.g., events), patterns, or anomalies. Each such key event, pattern, or anomaly may be associated with one or more roles and/or individuals, and insights service 64 may send notification of any such key event, pattern, or anomaly to the associated role(s) and/or individual(s). FIG. 13 shows examples of information 1301 ingested by insights engine 64, notifications 1302 that insights engine 64 may generate based on at least some of the information 1301 and roles 1303 to which each notification may be assigned.

The insights service 64 may receive the information 1301 from transcription service 63, from the call record database 66, from any of the other services or any other means. The roles and/or individuals to which each such keyword, pattern, or anomaly is associated may be preconfigured by the PSAP. For example, as shown in FIG. 13, notifications “Flagged Important Calls,” “Opportunities for Improved Training” and “Urgent Call Escalation” may all be pre-assigned to the role “911 Supervisors.” The pre-configured roles, events and associations may be stored in the communication processing server 25, for example in call record database 66, for access by the insights service 64.

The type of alert of notification (e.g., pop-up, email, etc.) may be preconfigured by the PSAP. One or more individuals may be pre-assigned to each role by the PSAP. The alerts or notifications may be sent to the recipient devices with notification of, for example, a call escalation or other change in workflow. Alternatively or in addition, insights service 64 may prepare actionable reports specialized for different user sets, such as 911 QA staff, supervisors, dispatchers, and various emergency response personnel including police, fire, and medical services. These reports may be customized based on information the user is seeking and/or may utilize artificial intelligence to provide highly relevant information.

In another example, insights service 64 may process the transcribed calls, for example in real time, and apply tags to the calls. The tags may be pre-configured, for example by the PSAP. The tags may be based on, for example, Computer-Aided Dispatch (CAD) nature codes, highlighting critical incidents like weapon-related calls, mental health crises, or location-based risks. The tags may also be based standard QA protocols common across PSAPs. This may allow supervisors to efficiently identify and review high-priority calls without needing to manually sift through extensive audio recordings. The tags may be pre-assigned to roles and/or individuals.

Insights service 64 may provide the notifications, alerts, insights and/or reports to the appropriate recipient device 27 in any manner. For example, insights service may use websockets.

Insights service 64 may process the transcribed text by using a large language model 1202 to compare the transcribed text with standard incident protocols. In this way insights service 64 may verify protocol adherence. For example, insights service 64 may check whether certain questions were asked and/or if the appropriate call flow was followed. Deviations, such as mishandling of incident types or skipped questions, may be sent to the assigned role or individual for review. This automated verification process may improve protocol adherence while providing deeper insights into call taker performance.

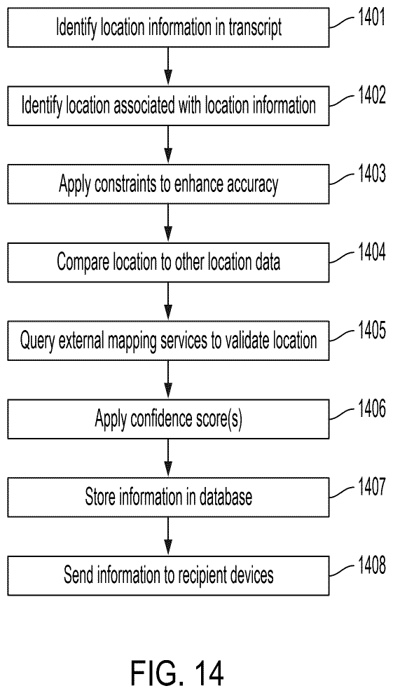

In another example shown in FIG. 14, insights service 64 may receive transcribed text from transcription service 63, for example in real time, and use the location validation service 1203 to validate location data received by communication processing server 25. At step 1401, location validation service 1203 processes the transcribed text to identify location information such as street names, intersections, and other landmarks. The location validation service may employ the large language model 1202 and/or keywork detection component 1201 to identify the location information. At step 1402, location validation service 1203 identifies a location associated with this location information, for example, by employing large language model 1202. At step 1403, location validation service 1203 may apply context and/or proximity-based constraints to the large language model (e.g., a 500-meter radius around the ANI/ALI location) to enhance the accuracy of the location identified in step 1402. At step 1404, location validation service 1203 compares the location obtained in step 1402 and/or 1403 to the location data received by communication processing server 25, for example the ALI, EED and/or ELS information. This comparison may validate the received location. At step 1405, the location validation service 1203 may further validate the received location by searching external services like Google Maps, OpenStreetMaps and Google Geocoder for the location obtained in step 1402 and/or 1403 to confirm that the location matches an actual address or geographic point. At step 1406 location validation service 1203 may give each location obtained in step 1402 and/or 1403 a confidence score based on, for example, proximity to the ALI and/or GPS coordinates, and similarity of the location to the address or geographic point in the external service query. The communication processing server 25 may prioritize the location or locations with the highest confidence score(s). At step 1407, location validation service 1203 stores, for example, the location information (e.g., street names, intersections, and other landmarks) obtained from the transcript, the location obtained from the large language model 1202 and/or the confidence scores in the call record database 66. At step 1408, insights service 64 may send the location(s) to the appropriate recipient device 27, for example a dispatcher computer, using the dispatcher or recipient information in the call record 100.

In another example, insights service 64 may process a call transcript with information from past calls and/or current calls. For example, insights service 64 may search a call transcript for keywords identified in other transcripts. Insights service may process the transcript with other transcripts from the same location and/or caller name to provide additional contextual information regarding the current call. For example, on a prior call from a 911 caller, the caller may have provided false information. Insights service 64 may also determine based on the location and keyword information that two calls involve the same incident, and can notify the responsible dispatchers and/or other recipients. This information from other transcripts may be obtained by the insights service 64 by, for example, processing prior transcripts and/or reviewing call records for the caller, and may be stored for example in the keywords field 110 in the call record database 66. Insights service 64 may provide the additional contextual information to the dispatcher and/or recipient devices identified by the call record 100.

In another example, insights service 64 may determine based on a review of the call transcript that additional recipients should be added to a call. For example, insights service 64 may determine that a helicopter is needed, and may then add a helicopter team to the list of other recipients 107. In another example, insights service 64 may determine that the call involves a fire by, for example, detecting fire in the video data and/or by reviewing the transcript, and may add the fire department to the list of other recipients 107. In another example, insights service 64 may determine that the incident is at a school by, for example, utilizing a map service such as Google maps, and may add the school resource officer and school staff to the list of other recipients 107.

The real-time insights, alerts, notifications and tailored reports provided by insights service 64 to recipient devices 27 may result in faster response times, more effective interventions, and/or better outcomes for individuals in need of emergency services. The real-time data analysis and tailored dissemination of information may also enhance situational awareness, improve resource allocation, and potentially save lives by providing precise and timely assistance.

Communication processing system 29 (FIG. 2) may also provide two-way translation of communications between the 911 caller device and a recipient device 27, thereby enabling real-time language interpretation during 911 calls, facilitating communication with non-English speaking callers. To do so communication processing system 29 may use a conversational AI-driven third-party bot and language detection models to identify the caller's language. The communication processing system 29 may send a message to the SIP server 23 to add the third-party bot as another caller. The dispatcher, for example, may enter text in English at the dispatcher computer, and the communication processing system 29 would send that text to the bot, which would speak the text in the chosen language for the 911 caller to hear. The AI bot may be powered by voice generation tools such as AWS Chime. The conversational AI bot may handle complex language constructs and contextual nuances, ensuring accurate, contextually relevant translations that maintain the flow and urgency of emergency communications. This translated audio may then be received by communication processing system 29 and processed as any other audio data.

ECC system 20 (FIG. 2) may also provide an interactive map interface for display on the recipient device, for example on display 221 (FIG. 2A) or screen 232 (FIG. 2B). The interactive map interface may display on a map the location(s) validated by location validation service 1203, allowing dispatchers and first responders to view the validated locations in an interactive format, and thereby allowing for better decision-making during emergency responses. Where multiple locations are identified, the interactive map interface may indicate the relative confidence scores of the different locations. Dispatchers or first responders may click on or touch a validated location to view additional information, including for example the corresponding transcript snippet where the location was mentioned. The interactive map interface may also provide navigation options to assist first responders in traveling to the location.

The architecture of the communication processing server 25, for example as shown in FIG. 6, improves fault tolerance by separating the functionality of the communication processing server 25 into individual isolated components that can independently operate even if other components become unavailable. The boundaries of the various components of the communication processing server 25 described above are illustrative, and functionality described as being performed by one component may instead, or in addition, be performed by one or more other components of the communication processing server 25. For example, functionality described above as being performed by the insights service 64 may instead be performed by the transcription service 63, or vice-versa, which may further increase the efficiency and performance of the real time analysis of transcribed text.

Embodiments described herein transcribe real-time radio communications across multiple talk groups and provide information and insights from these radio communications to allow dispatchers, supervisors, and emergency personnel to track communications more effectively. This is made possible by the seamless integration of communication processing client 24 into the PSAP network 6 and seamless interception/reception data from radio communications system 28.

Embodiments described herein provide a comprehensive approach to managing emergency call data and are enabled by a robust application architecture that includes the seamless installation of the communication processing client 24 in the PSAP. Additionally, embodiments described herein extend the infrastructure to meet public safety standards of high reliability, availability, and security. This may involve deploying the communication processing server 25 in multiple cloud regions with highly available configurations for critical services such as WebRTC deployment and communication processing server 25. Mission-critical services may be deployed with, for example, at least three instances running in every active region, spread across at least three Availability Zones (AZs). Such deployment improves stability in each region and allows each region to support the full load of the system in the event of another region's failure. Every mission-critical service may be deployed across, for example, two active cloud regions. Failover of mission-critical services may occur automatically without user input.

Each regional deployment may be ensconced in a secure Virtual Private Cloud (VPC), manifesting an isolated network domain to bolster security measures. The VPCs may be interlinked via peering arrangements, facilitating seamless network communication within an AWS ecosystem. These deployments are also highly scalable, which allows the systems to handle a high volume of simultaneous emergency calls without performance degradation.

The regional deployments may also employ Kubernetes Clusters, leveraging Kubernetes Service to orchestrate containerized applications across multiple availability zones to improve system redundancy and resilience. Each cluster may include a suite of services, for example an Istio service mesh built using FIPS compliant cryptography, representing the network control plane. The Istio service mesh may orchestrate service-to-service communication, enforce security policies, and aggregate service metrics. Inter-regional connectivity may be assured through mutual TLS (mTLS) protocols, providing for secure, authenticated communication channels across the service mesh that spans the multiple availability zones and regions.

The deployments may further use a Relational Database Service (RDS) for data persistence, with configurations for Master and Read Replicas to ensure data redundancy and high availability. Simple Storage Service (S3) buckets may be employed for redundant data storage, for example for call record database 66 and long-term storage 72, with encryption protocols to safeguard data.

The infrastructure may incorporate a Geo-Aware DNS setup, indicative of a dynamic DNS resolution system tailored to direct user traffic based on geographic location, thereby optimizing response times and service reliability. For example, audio calls and requests from the communication processing client 24 may be routed to the nearest regional deployment, and that connection may be persistent for the duration of the call.

In the event of a service disruption, embodiments described herein may initiate an automated failover process whereby a secondary Read Replica is promoted to a Master within the RDS ecosystem, thus maintaining the operational continuity of the system. In the event of a failure of an entire region, a Read Replica in another region may be promoted to master database and requests to write data may be routed to that new master database. Embodiments described herein may also utilize existing S3 database and file replication mechanisms between regions, which contributes to a comprehensive disaster recovery strategy and promotes data consistency across the distributed network.

Communication in embodiments described herein may be encrypted in-transit with a minimum of TLS 1.2+, and data at rest may be encrypted with a minimum of AES-256 and a preference towards leveraging AWS KMS. Sensitive fields and personally identifiable information may be additionally encrypted at a field-level with AES-256-GCM.

Roles may be established at an application level, and audit logs may be kept and provided. Deployed systems may be protected by, for example, AWS SSO and strongDM, and MFA may be enforced throughout internal systems. Database and S3 static asset backups may be maintained cross-regionally with an RPO (recovery point objective) targeting less than a minute. Backups may be encrypted at-rest with AWS KMS.

While the embodiments described herein primarily involve emergency call centers. the embodiments can generally be implemented in any call center environment.

1. A system for processing an emergency call between an emergency caller and a dispatcher device at an emergency call center, the system comprising:
a network switched port analyzer (“SPAN”) configured to mirror SIP packets sent by a SIP server;
a call processing client configured to:
obtain the SIP packets from the network SPAN;
obtain a caller device network address and a dispatcher device network address from initial SIP packets of the emergency call;
obtain emergency call SIP packets from the SIP packets based on the caller device network address and the dispatcher device network address;
extract raw audio data from the emergency call SIP packets; and
extract metadata from the emergency call the SIP packets;
an ordered messaging bridge configured to receive the metadata and raw audio data from the call processing client; and
a call processing server configured to:
obtain the raw audio data and metadata from the ordered messaging bridge;
transcribe the raw audio data to produce a transcript;
process the transcript to identify key information; and
provide a notification to the dispatcher regarding the key information.

2. The system of claim 1, further comprising a radio communication system for managing emergency radio communications, wherein the call processing client is configured to intercept radio SIP packets from the radio communication systems and send the raw radio data to the call processing server.

3. The system of claim 1, wherein the call processing server comprises a recorder service for storing the raw audio data as a recorded call.

4. The system of claim 3, wherein the recorder service is further configured to make the recorded call available to the dispatcher computer.

5. The system of claim 3, wherein the recorder service is further configured to transform the raw audio data using a mu-law algorithm.

6. The system of claim 3, wherein the recorder service is configured to store the raw audio data in a short-term storage, and move the raw audio data from the short-term storage to a long-term storage when the emergency call has ended.

7. The system of claim 1, wherein the call processing server further comprises a transcription service for performing the transcription of the raw audio data; wherein the transcription service is further configured to provide the transcription to the dispatcher computer in real-time.

8. The system of claim 1, wherein the call processing server further comprises a transcription service for performing the transcription of the raw audio data; wherein the transcription service is further configured to provide a complete transcription to the dispatcher computer when the emergency call has ended.

9. The system of claim 1, wherein the call processing server further comprises a call record database for storing call records.

10. The system of claim 1, wherein the call processing server further comprises an insights service for performing the processing of the transcript to identify key information, wherein the insights service is configured to:
identify at least one word in the transcript related to a location associated with the emergency call;
determine the location associated with the emergency call based on the at least one word; and
compare the location with other location data to validate the location.

11. The system of claim 1, wherein the call processing server further comprises a livestream service for streaming video from the emergency caller's device to the dispatcher computer.

12. The system of claim 1, wherein the call processing server further comprises a routing service configured to:
obtain the raw audio data and metadata comprising a unique call identifier;
determine if the emergency call exists in a call record database based on the unique call identifier;
create a new call record if the emergency call does not exist in the call record database, otherwise retrieve an existing call record; and
store in the new call record or the existing call record the location data, a unique call identifier and information sufficient to identify the dispatcher computer.

13. The system of claim 1, wherein the call processing client is further configured to obtain from the SIP server and provide to the ordered messaging bridge at least one of automatic number identification data and automatic location identification data.

14. The system of claim 1, wherein the ordered messaging bridge and the call-processing server are cloud-based.

15. The system of claim 1, further comprising an ANI/ALI server configured to receive automatic number identification data and automatic location identification data from the SIP server and to make the automatic number identification data and automatic location identification data available to the call processing server.

16. The system of claim 1, further comprising a radio communications system configured to provide radio SIP packets to the call processing server for transcription.

17. A method for processing an emergency call between an emergency caller and a dispatcher device at an emergency call center, the method comprising:
intercepting SIP packets from a SIP server using a network switched port analyzer (“SPAN”);
at a call processing client:
obtaining SIP packets from the network SPAN;
obtaining a caller device network address and a dispatcher device network address from initial SIP packets of the emergency call;
obtaining emergency call SIP packets from the SIP packets based on the caller device network address and the dispatcher device network address;
extracting raw audio data from the emergency call SIP packets;
extracting metadata from the emergency call the SIP packets; and
sending the raw audio and metadata to an ordered messaging bridge;
at the call processing server:
obtaining the raw audio data and metadata from the ordered messaging bridge;
transcribing the raw audio data to produce a transcript at the call processing server;
processing the transcript to identify key information; and
providing a notification regarding the key information to a dispatcher assigned to handle the emergency call.

18. The method of claim 17, wherein the processing of the transcript is performed using artificial intelligence.

19. The method of claim 18, wherein the processing of the transcript comprises:
identifying at least one word in the transcript related to a location associated with the emergency call;
determining the location associated with the emergency call based on the at least one word; and
comparing the location with other location data to validate the location.

20. The method of claim 19, wherein the comparing step comprises inputting the location to a third-party mapping service to determine if the location is valid.
